(19) United States
(12) Patent Application Publication
(10) Pub. No.: US 2008/0225092 A1
(43) Pub. Date: Sep. 18, 2008

(54) Ink Container

(75) Inventors: Nigel John Counihan, Lincolnshire (GB); John William Studholme, Lincolnshire (GB); Kevin Vickers, Lincolnshire (GB)

Correspondence Address: PEARNE & GORDON LLP, 1801 EAST 9TH STREET, SUITE 1200, CLEVELAND, OH, 44114-3108, US

(73) Assignee: DYNAMIC CASSETTE INTERNATIONAL LTD., Boston, Lincolnshire (GB)

(21) Appl. No.: 10/597,484

(22) PCT Filed: Feb. 7, 2005
(86) PCT No.: PCT/GB2005/000403

§ 371 Date: Sep. 29, 2006

(30) Foreign Application Priority Data
Feb. 6, 2004 (GB) 0402655.5

(51) Int. Cl. B41J 2/175

(52) U.S. Cl. 347/86

(57) ABSTRACT

An ink container 10 comprises a serial arrangement of three chambers 32, 34, 36. The ink container 10 defines an ink supply port 42, 56, 60 for each chamber 32, 34, 36. The ink supply port 60 of one chamber 32 is displaced from alignment with a porous member in the chamber 32.

The invention relates to an ink container.

EP-A-655336 discloses an ink container which is arranged to be installed in a holder which carries a thermal print head. The holder is inserted in a computer printer. The ink container defines three chambers separated by an upright, T shaped partitioning wall. There is an outlet from each chamber through the floor of the container. Ink tapping pipes are received in the ink outlets to convey ink to the print head. The ink tapping pipes in the floor of the holder are arranged at the points of an L shape with the outlets of the ink container in corresponding positions.

Compared with a conventional three chamber ink container, in which the chambers are side by side in series, the ink container of EP-A-655336 introduces certain complexities in manufacture. Thus, the ink injection needles for filling the chambers cannot be in a line, but instead must be out of alignment with each other in order to reflect the arrangement of the chambers. Also, whereas in the conventional cartridge, the ink absorbing members in the chambers are all the same size and shape, at least two different cross sections of ink absorbing member are required in the ink container of EP-A-655336 because of the T shaped partition. Furthermore, it is more complex to insert the ink absorbing members in manufacture, as the major dimension of the chambers to receive the ink absorbing members in plan is not always in the same direction, and as the centres of the chambers are not in a line.

According to one aspect of the invention there is provided an ink container comprising a serial arrangement of three chambers, the container defining an ink supply port for each chamber through which ink can be drawn from the chamber, the ink supply port of the first of the chambers being displaced from alignment with the first chamber.

According to another aspect of the invention there is provided an ink container comprising a serial arrangement of three chambers, each chamber defining a member receiving volume to receive a negative pressure producing member to hold ink, the container defining an ink supply port for each chamber through which ink can be drawn from the chamber, the ink supply port of one of the chambers being displaced from alignment with the member receiving volume of that chamber.

In this way, a displacement of the ink supply port enables unusual, for example, non-linear arrangements of ink withdrawal members to be catered for, while maintaining the ease of manufacture of a conventional cartridge with a serial arrangement of chambers. In particular, a cartridge with in line chambers can be made with an offset outlet port so that it can be received in a holder, such as that disclosed in EP-A-655336.

Each member receiving volume is preferably of the same width and/or depth and/or height. Each member receiving volume may be rectangular viewed in the direction of insertion of a negative pressure producing member into the volume. Each member receiving volume may have an opening for insertion of a negative pressure producing member, the opening being covered by a lid. The openings may be aligned side by side.

Preferably, the ink supply port of the first chamber is aligned with the second of the three chambers.

The outlets from the three chambers may be in any surface of the ink container but preferably the outlets from the three chambers are underneath the ink container. The ink outlets may be at the same height.

Preferably each chamber includes a negative pressure producing member. The negative pressure producing members may be identical.

In a preferred embodiment, the container has a manifold associated with the first chamber, the manifold having an inlet aligned with the first chamber and an outlet displaced from alignment with the first chamber. The manifold may be a separate part to be attached to the main part of the container, or may be integral with the container. The manifold may contain a negative pressure producing member.

Preferably, the ink container defines an ink fill hole for each chamber. The ink fill holes are preferably provided in a common surface of the ink container and preferably are in a serial arrangement, most preferably being arranged on a notional straight line, which may be parallel to the plane of one surface of the cartridge, which may be the major surface of the cartridge.

Preferably, the ink container defines a breather hole for each chamber. The breather holes are preferably provided in a common surface of the ink container and preferably are in a serial arrangement, most preferably being arranged on a notional straight line, which may be parallel to the plane of one surface of the container, which may be the major surface of the container. The container preferably further includes an element including a plurality of projections, each projection being received in a breather hole of the container. The element may prevent the container from being fully engaged in a printer and at least part of the element may be arranged to be removed to enable the container to be fully engaged in a printer.

An embodiment of the invention will now be described by way of example and with reference to the accompanying drawings in which:

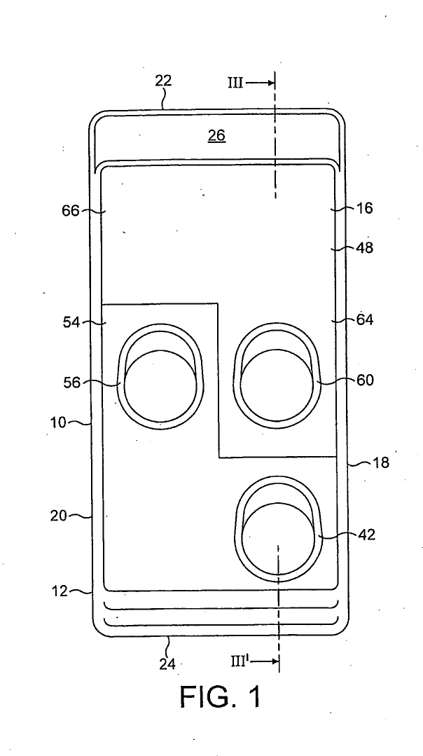

FIG. 1 is an underneath plan view of the ink container of the embodiment of the invention;

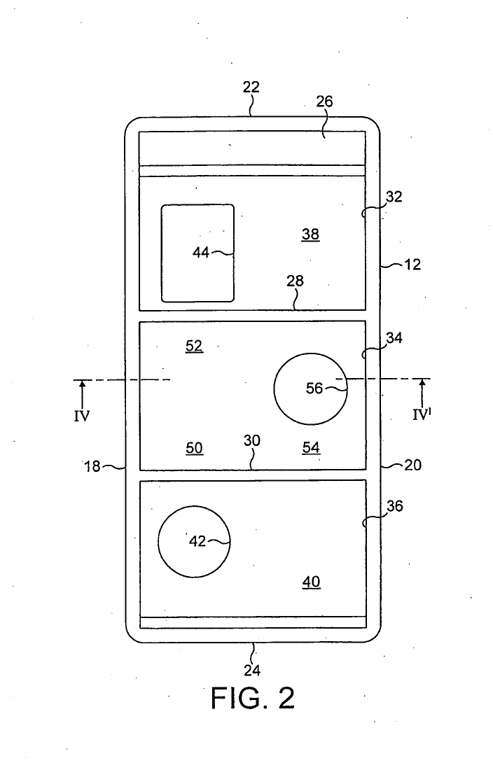

FIG. 2 is a top plan view of the main body of the ink container of FIG. 1 with the lid removed;

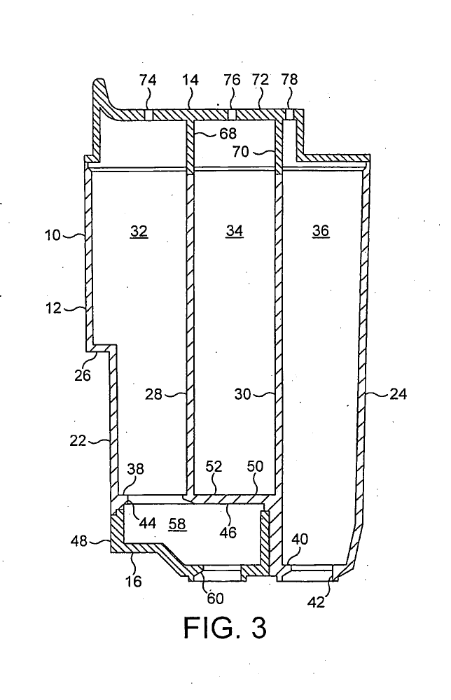

FIG. 3 is a side elevation in cross section of the ink container of FIG. 1 at III-III in FIG. 1;

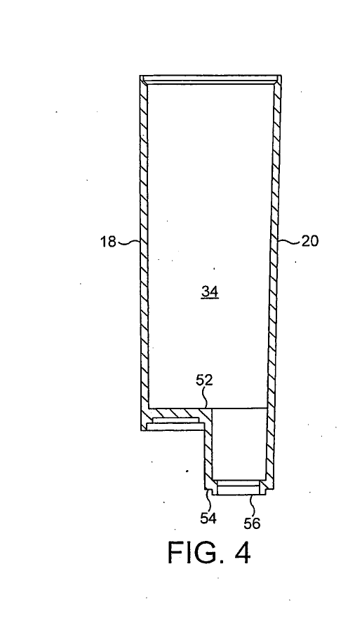

FIG. 4 is an end elevation in cross section of the main body of the ink container of FIG. 1 at IV-IV in FIG. 2;

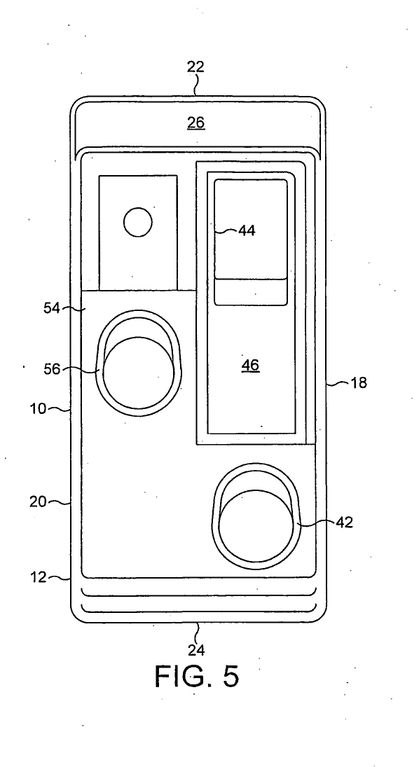

FIG. 5 is an underneath plan view of the ink container of the embodiment without the manifold;

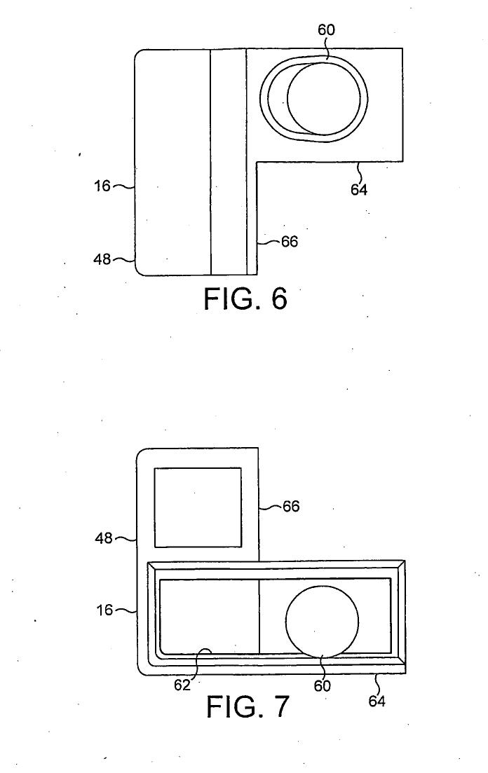

FIG. 6 is an underneath plan view of the manifold of the embodiment;

FIG. 7 is a top plan view of the manifold of the embodiment;

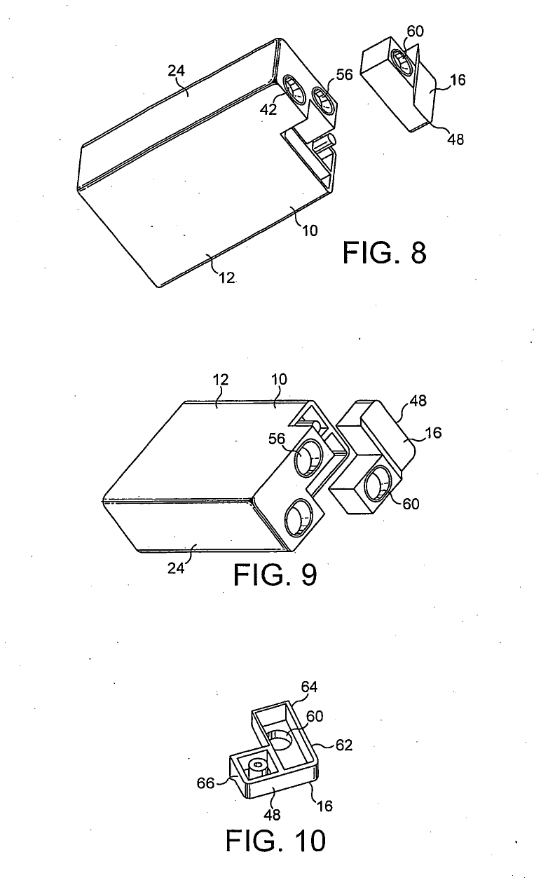

FIG. 8 is an exploded view of the main body and manifold of the ink container of FIG. 1;

FIG. 9 is another exploded perspective view of the main body and manifold of the ink container of FIG. 1;

FIG. 10 is a perspective view of the manifold of the embodiment;

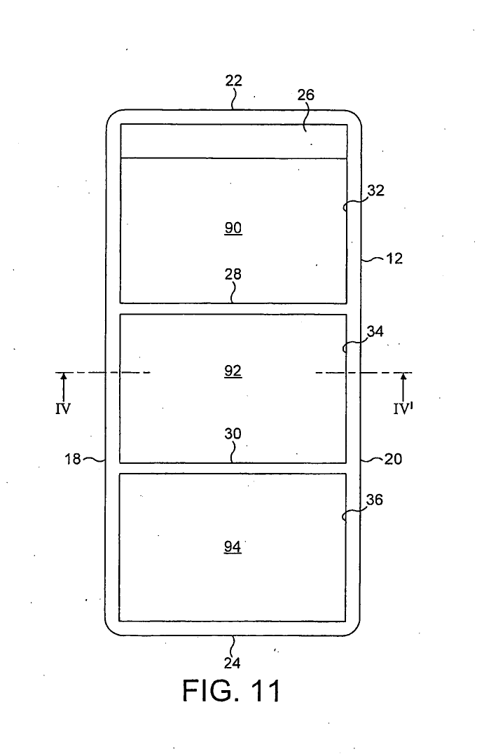

FIG. 11 is a top plan view of the main body of the ink container of FIG. 1 with the porous members in place;

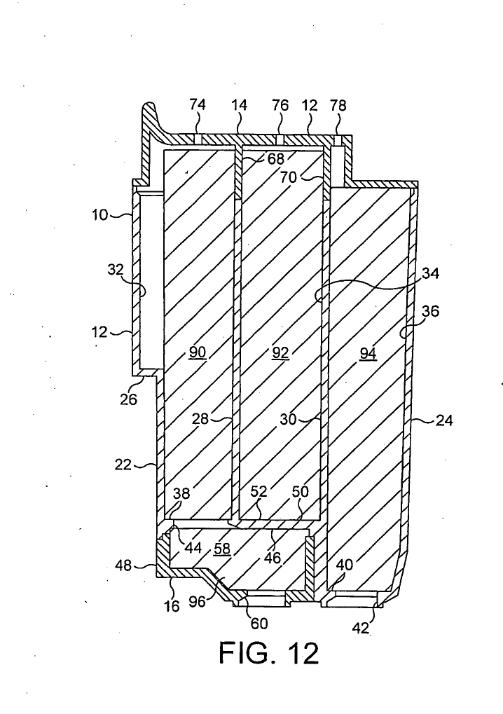

FIG. 12 is the view of FIG. 3 with the porous members in place;

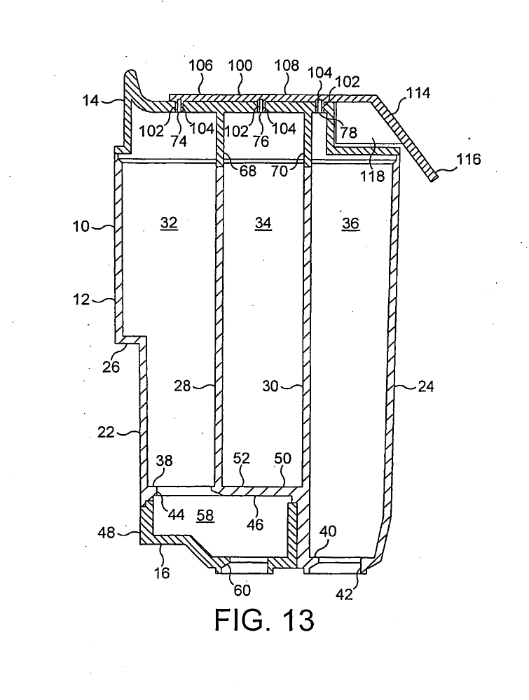

FIG. 13 is the view of FIG. 3 showing an element fitted to the container;

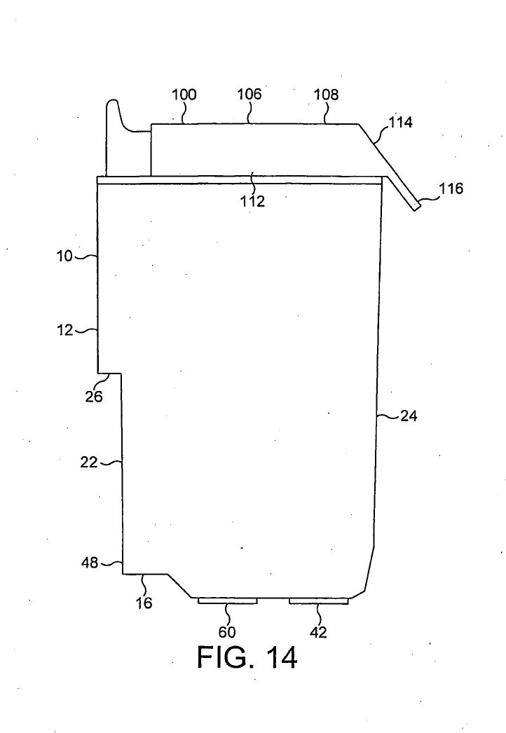

FIG. 14 is a side elevation of the ink container of FIG. 1;

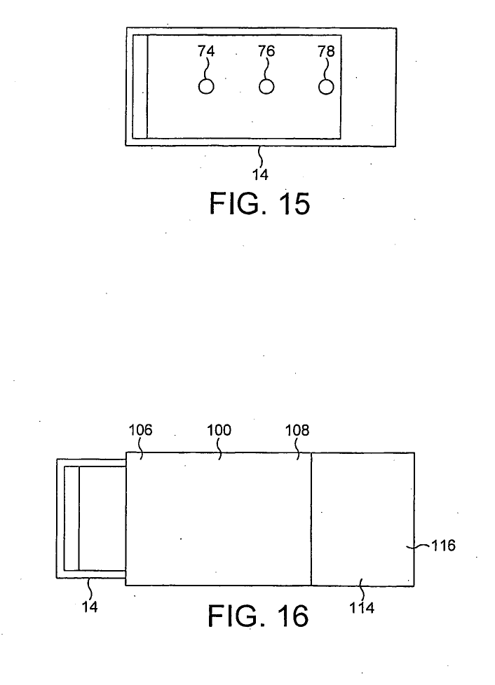

FIG. 15 is a top plan view of the ink container of FIG. 1 without the element; and

FIG. 16 is a top plan view of the ink container of FIG. 1 with the element.

The ink container 10 of the embodiment of the invention comprises a main body 12, a lid 14 and a manifold 16.

The main body 12 is generally in the form of an open topped box of rectangular cross section in plan.

The main body 12 thus comprises two major surfaces constituted by the side walls 18, 20 and includes two end walls 22, 24, one of which includes a step 26. The main body 12 is spanned by two partition walls 28, 30 which extend between the side walls 18, 20 and which lie generally parallel to the end wall 24 to divide the main body 12 into three chambers 32, 34, 36 arranged in series. Below the level of the step 26, each chamber 32, 34, 36 has substantially the same cross section in plan. A porous member 90, 92, 94 (which constitutes the aforesaid “negative pressure producing member”) is provided in each of the chambers 32, 34, 36 as shown in FIGS. 11 and 12, for example.

The floor 38 of the first ink chamber 32 adjacent the stepped end wall 22 is at a higher level than the floor 40 of the third ink chamber 36 adjacent the other end wall 24. An ink outlet 42 is defined in the floor 40 of the third ink chamber 36.

There is an opening 44 in the floor 38 of the first chamber 32 which leads into the manifold 16. The manifold 16 is defined by the under surface 46 of the main body 12 and a manifold piece 48. The floor 50 of the central chamber 34 is stepped from side to side so that one part 52 is at the level of the floor 38 of the first chamber 32 adjacent the wall 20, while the other part 54 is at the level of the floor 40 of the third ink chamber 36. The lower part 54 of the floor 50 defines an ink outlet 56. The manifold piece 48 defines a cavity 58 connecting the opening 44 with an ink outlet 60 which lies underneath the raised part 52 of the floor 50 of the central chamber 34 and is generally aligned with the central chamber 34 rather than the first chamber 32 in the sense that it is underneath the second chamber 34 rather than the first chamber 32. The ink outlet 60 lies alongside the ink outlet 56 from the second chamber 34 and is adjacent the side wall 18. The ink outlet 42 from the third chamber 36 is also adjacent the side wall 18 so that the ink outlets 42, 56, 60 are arranged in an L shape.

The manifold piece 48 is generally L shaped as shown in FIGS. 6 and 7 and defines a long upper opening 62 to communicate with the opening 44 in the floor 38 of the first chamber 32 and also defines the ink outlet 60 in a first limb 64 of the L shaped piece 48. The other limb 66 of the manifold piece 48 is arranged to be attached to the underside 46 of the main body 12 adjacent the opening 44, in other words next to the side wall 20.

The lid 14 defines two walls 68, 70 which depend from the main body 72 of the lid 14 to meet the upper edges of the partition walls 28, 30 respectively. An air hole 74, 76, 78, is defined in the main part 72 of the lid 14 for each chamber 32, 34, 36. The air holes 74, 76, 78 are on a central notional line parallel to the major walls 18, 20 of the container 10.

An element 100 is fitted to the lid 14. The element 100 includes three projections 102 depending from the main body 106. Each projection 102 defines a blind bore 104 from its free end upwards. Each projection 102 is received in an air hole 74, 76, 78. The main body 106 comprises a plate-like top part 108 which lies flat on top of the flat top surface 110 of the lid 14. The top plate 108 has a skirt part 112 depending from each side to lie alongside the lid 14 and has an end part 114 which is angled downwards from the end of the top part 108 and extends beyond the end of the cartridge to form a finger tab 116. A rib 118 extends vertically downwards from the top part 108 and end part 114 to engage the lid 14.

To assemble the cartridge, an L-shaped porous member 96 is inserted into the manifold piece 48 and the manifold piece 48 is bonded to the underside 46 of the main body 12 of the ink container 10. A porous member 90, 92, 94 is inserted into each of the chambers 32, 34, 36, and the lid 14 is then placed on top of the main body 12, and the lower edges of the main part 72 of the lid 14 are bonded to the upper edges of the walls 18, 20, 24 of the main body 12, and the depending walls 68, 70 are bonded to the upper edges of the partition walls 28, 30. To fill the ink container 10, ink is injected through the air holes 74, 76, 78 in the lid 14 of the ink container 10. The element 100 is then fitted by aligning the projections 102 with the air holes 74, 76, 78 and pushing the element down.

It is seen that the ink chambers 32, 34,36 are of the same cross section in plan at least below the level of the step 26 so that porous members 90, 92, 94 of the same cross section can be used, simplifying manufacture. Also, the ink container 10 can be filled using ink input needles which are arranged in a line, rather than the L shaped arrangement necessitated in EP-A-655336. Furthermore, because of the serial arrangement of the chambers 32, 34, 36, the breather holes 74, 76, 78 are in a line and therefore an element 100 of the type disclosed in GB-A-2350323 can be employed. The element 100 is grasped by the finger tab 116 and pulled upwards. It will then break leaving the hollow projections 102 in the air holes 74, 76, 78. As the projections are hollow, air can enter the container 10.

1. An ink container comprising a serial arrangement of three chambers, each chamber defining a member receiving volume to receive a negative pressure producing member to hold ink, the container defining an ink supply port for each chamber through which ink can be drawn from the chamber, the ink supply port of one of the chambers being displaced from alignment with the member receiving volume of that chamber.

2. An ink container as claimed in claim 1, wherein each member receiving volume is of the same width.

3. An ink container as claimed in claim 1, wherein each member receiving volume is of the same depth.

4. An ink container as claimed in claim 1, wherein each member receiving volume is of the same height.

5. An ink container as claimed in claim 1, wherein each member receiving volume is rectangular viewed in the direction of insertion of a negative pressure producing member into the volume.

6. An ink container as claimed in claim 1, wherein each member receiving volume has an opening for insertion of a negative pressure producing member, the opening being covered by a lid.

7. An ink container as claimed in claim 6, wherein the openings are side by side in a straight line.

8. An ink container as claimed in claim 1, wherein the ink supply port of the first chamber in the serial arrangement is displaced from alignment with the member receiving volume of the first chamber.

9. An ink container as claimed in claim 1, wherein the ink supply port of one chamber is displaced to be aligned with the member receiving volume of another of the three chambers.

10. An ink container as claimed in claim 9, wherein the ink supply port of the first chamber is displaced to be aligned with the member receiving volume of the second chamber in the serial arrangement.

11. An ink container as claimed in claim 1, wherein the outlets from the chambers are underneath the ink container.

12. An ink container as claimed in claim 11, wherein the ink outlets are at the same height.

13. An ink container as claimed in claim 1, wherein the member receiving volume of each chamber includes a negative pressure producing member.

14. An ink container as claimed in claim 13, wherein the negative pressure producing members are identical.

15. An ink container as claimed in claim 1, wherein the container has a manifold associated with the displaced output port chamber, the manifold having an inlet aligned with the member receiving volume of the chamber and an outlet displaced from alignment with the member receiving volume of the chamber.

16. An ink container as claimed in claim 15, wherein the manifold is a separate part to be attached to the main part of the container.

17. An ink container as claimed in claim 16, wherein the manifold contains a negative pressure producing member.

18. An ink container as claimed in claim 1, wherein the ink container defines an ink fill hole for each chamber, the ink fill holes being provided in a common surface of the ink container and being in a serial arrangement, and being arranged on a notional straight line.

19. An ink container as claimed in claim 18, wherein the said notional straight line is parallel to the plane of one surface of the container.

20. An ink container as claimed in claim 19, wherein the said notional straight line is parallel to the plane of the major surface of the container.

21. An ink container as claimed in claim 1, wherein the ink container defines a breather hole for each chamber, the breather holes being provided in a common surface of the ink container and being in a serial arrangement, being arranged on a notional straight line.

22. An ink container as claimed in claim 21, wherein the breather holes are arranged on a notional straight line which is parallel to the plane of one surface of the container.

23. An ink container as claimed in claim 22, wherein the breather holes are arranged on a notional straight line which is parallel to the plane of the major surface of the container.

24. An ink container as claimed in claim 21, wherein the container further includes an element including a plurality of projections, each projection being received in a breather hole of the container.

25. An ink container as claimed in claim 24, wherein the element prevents the container from being fully engaged in a printer and at least part of the element is arranged to be removed to enable the container to be fully engaged in a printer.

26. An ink container as claimed in claim 1, wherein each member receiving volume is of the same width and depth.

27. An ink container as claimed in claim 1, wherein each member receiving volume is of the same width and depth and height.

28. An ink container comprising a serial arrangement of three chambers, each chamber defining a member receiving volume to receive a negative pressure producing member to hold ink, the container defining an ink supply port for each chamber through which ink can be drawn from the chamber by means of an ink tapping pipe of the printer to be received in the ink supply port to convey ink to the print head of the printer, the ink supply port of one of the chambers being displaced from alignment with the member receiving volume of that chamber.

29. An ink container comprising a serial arrangement of three chambers, each chamber defining a member receiving volume to receive a negative pressure producing member to hold ink, the container defining an ink supply port for each chamber through which ink can be drawn from the chamber, the ink supply port of one of the chambers being displaced from alignment with the member receiving volume of that chamber, wherein the container has a manifold associated with the displaced ink supply port chamber, the manifold having an inlet aligned with and communicating with the member receiving volume of the chamber and the manifold having an outlet displaced from alignment with the member receiving volume of the chamber, the outlet forming the displaced ink supply port.
